(19) United States
(12) Patent Application Publication
(10) Pub. No.: US 2023/0373516 A1
(43) Pub. Date: Nov. 23, 2023

(54) APPARATUS FOR CONTROLLING AN AUTONOMOUS DRIVING, VEHICLE SYSTEM HAVING THE SAME METHOD THEREOF

(71) Applicants: Hyundai Motor Company, Seoul (KR); Kia Corporation, Seoul (KR)

(72) Inventor: Sang Bok Won, Hwaseong (KR)

(21) Appl. No.: 17/990,173

(22) Filed: Nov. 18, 2022

(30) Foreign Application Priority Data
May 18, 2022 (KR) 10-2022-0061007

(51) Int. Cl. B60W 50/16; B60W 60/00; B60K 35/00; G06V 10/764; G06V 20/58; G06V 10/98

(52) U.S. Cl. CPC B60W 50/16; B60W 60/0015; B60K 35/00; G06V 10/764; G06V 20/58; G06V 10/98; B60W 2050/146

(57) ABSTRACT

The present disclosure relates to an autonomous driving control apparatus, a vehicle system comprising the same, and a method thereof. An exemplary embodiment of the present disclosure provides an autonomous driving control apparatus comprising an interface device configured to display a driving path of a vehicle and vehicle surrounding objects, and a processor configured to visually classify and display one or more vehicle surrounding objects on the interface device based on a recognition status of the one or more vehicle surrounding objects or a risk degree of the one or more vehicle surrounding objects based on recognition information of the one or more vehicle surrounding objects while driving.

### CROSS-REFERENCE TO RELATED APPLICATION(S)

This application claims, under 35 U.S.C. § 119(a), the benefit of Korean Patent Application No. 10-2022-0061007, filed in the Korean Intellectual Property Office on May 18, 2022, the disclosure of which is incorporated herein by reference in its entirety.

### BACKGROUND

### Technical Field

Embodiments of the present disclosure relate to an autonomous driving control apparatus, a vehicle system comprising the same, and a method thereof, and, more particularly, to a technique for notifying a user of recognition status of information related to an object around a vehicle and complementing it.

### Background

Recently, the interest in autonomous vehicles has increased. A currently commercially available autonomous vehicle may apply advanced driver assistance systems (ADAS) not only to free a user from simple tasks, such as operating a steering wheel and pedals during driving, but also to prevent accidents in advance, by reducing mistakes caused by user's carelessness.

That is, the advanced driver assistance system (ADAS) is a user assistance system configured to prevent accidents by controlling braking or steering of a vehicle by recognizing and/or determining surrounding conditions while driving using various advanced detection sensors, etc.

A conventional advanced user assistance system does not provide information such as whether it has failed to recognize obstacles around the vehicle and which is being tracked by determining which object to be controlled, and thus a user must keep an eye on a driving situation at all times and remain able to intervene in braking and steering control whenever necessary. Accordingly, the user has anxiety and tension while using the autonomous driving function, which lowers satisfaction of the autonomous driving system.

The above information disclosed in this Background section is only for enhancement of understanding of the background of the disclosure, and therefore, it may contain information that does not form the prior art that is already known in this country to a person of ordinary skill in the art.

### SUMMARY

An exemplary embodiment of the present disclosure has been made in an effort to provide an autonomous driving control apparatus, a vehicle system comprising the same, and a method thereof, capable of increasing user satisfaction by effectively notifying a user of a recognition status of an object around a vehicle of an autonomous driving apparatus and improving a recognition function of the object around the vehicle based on user input information.

The technical objects of the present disclosure are not limited to the objects mentioned above, and other technical objects not mentioned may be clearly understood by those skilled in the art from the description of the claims.

An exemplary embodiment of the present disclosure provides an autonomous driving control apparatus comprising an interface device configured to display a driving path of a vehicle and one or more vehicle surrounding objects, and a processor configured to visually classify and display the one or more vehicle surrounding objects on the interface device based on a recognition status of the one or more vehicle surrounding objects or a risk degree of the one or more vehicle surrounding objects based on recognition information of the one or more vehicle surrounding objects while driving.

In an exemplary embodiment of the present disclosure, the processor, based on the recognition status of the one or more vehicle surrounding objects or the risk degree of the one or more vehicle surrounding objects, may be configured to control the one or more vehicle surrounding objects to be classified and displayed according to at least one of colors of the one or more vehicle surrounding objects or shapes of the one or more vehicle surrounding objects.

In an exemplary embodiment of the present disclosure, the processor may be configured to control the one or more vehicle surrounding objects to be notified to a user by using at least one of tactile, vibration, auditory, or any combination thereof based on the recognition status of the one or more vehicle surrounding objects or the risk degree of the one or more vehicle surrounding objects.

In an exemplary embodiment of the present disclosure, the risk degree of the one or more vehicle surrounding objects may comprise a possibility of collision with a vehicle.

In an exemplary embodiment of the present disclosure, the processor may be configured to control the one or more vehicle surrounding objects to be displayed together with unique IDs by assigning the unique IDs to the one or more vehicle surrounding objects.

In an exemplary embodiment of the present disclosure, the processor, when a vehicle surrounding object is determined as an undetermined control target because recognition accuracy of the vehicle surrounding objects is low, may be configured to determine the vehicle surrounding object as a control target based on a user command.

In an exemplary embodiment of the present disclosure, the processor may be configured to recognize the user command through at least one of voice command recognition, a button operation, a touch input, or any combination thereof.

In an exemplary embodiment of the present disclosure, the processor, when the user command is inputted as a voice command, the voice command may comprise a unique ID of the vehicle surrounding object and an action to be performed.

In an exemplary embodiment of the present disclosure, the unique ID may be given based on type information of the vehicle surrounding object, and the action to be performed may comprise at least one of actions of determining the vehicle surrounding object as a control target, releasing a control target of an object determined as the control target, deleting a misrecognized vehicle surrounding object, or any combination thereof.

In an exemplary embodiment of the present disclosure, the processor may be configured to control the one or more vehicle surrounding objects to be displayed in a first color or a first shape when recognition accuracy of the one or more vehicle surrounding objects is lower than a predetermined reference value, and to control the vehicle surrounding object to be marked in a second color or in a second shape on a driving path when the vehicle surrounding object is determined as a control target based on a user command.

In an exemplary embodiment of the present disclosure, the processor may be configured to control the vehicle surrounding object to be displayed in a third color or in a third shape when it is necessary to track the vehicle surrounding object based on the user command.

In an exemplary embodiment of the present disclosure, the processor may be configured to control the vehicle to maintain a safe distance with a tracking target, and to continue to track the vehicle surrounding object when the vehicle surrounding object is determined as the tracking target.

In an exemplary embodiment of the present disclosure, the processor may be configured to control the vehicle surrounding object to be marked in the first color or the first shape on the driving path, and to control an unique ID of an object for providing information to be displayed together when recognition accuracy of the vehicle surrounding object is lower than a predetermined reference value and the vehicle surrounding object is determined as a target for providing information rather than a control target, and to control the vehicle surrounding object to be displayed in a fourth color or a fourth shape when the vehicle surrounding object is determined as an information usage target based on a user command.

In an exemplary embodiment of the present disclosure, the processor may be configured to control an object around the vehicle to be marked in a fifth color or fifth shape on the driving path when the vehicle surrounding object is not the control target.

In an exemplary embodiment of the present disclosure, the processor may be configured to control the vehicle surrounding object to be marked in the first color or the first shape on a driving path when recognition accuracy of the vehicle surrounding object is lower than a predetermined reference value, and to delete the marking of the vehicle surrounding object on the driving path based on the user command.

In an exemplary embodiment of the present disclosure, the interface device may comprise at least one of a head-up display (HUD), a cluster, an audio video navigation (AVN), a human machine interface (HM), a user setting menu (USM), a monitor, an AR-enabled windshield display, or any combination thereof.

An exemplary embodiment of the present disclosure provides a vehicle system comprising a sensing device configured to acquire vehicle surrounding object information and vehicle surrounding environment information, and an autonomous driving control apparatus configured to visually classify and display one or more vehicle surrounding objects based on a recognition status of the one or more vehicle surrounding objects or a risk degree of the one or more vehicle surrounding objects based on recognition information of the one or more vehicle surrounding objects while driving.

An exemplary embodiment of the present disclosure provides an autonomous driving control method, comprising acquiring recognition information of one or more vehicle surrounding objects while driving, and visually classifying and displaying the one or more vehicle surrounding objects based on a recognition status of the one or more vehicle surrounding objects or a risk degree of the one or more vehicle surrounding objects based on recognition information of the one or more vehicle surrounding objects.

In an exemplary embodiment of the present disclosure, the visually classifying and displaying of the one or more vehicle surrounding objects may comprise, based on the recognition status of the vehicle surrounding objects or the risk degree of the vehicle surrounding objects, controlling one or more vehicle surrounding objects to be classified and displayed according to at least one of colors of the one or more vehicle surrounding objects or shapes of the one or more vehicle surrounding objects.

In an exemplary embodiment of the present disclosure, the visually classifying and displaying of the one or more vehicle surrounding objects may further comprise, when a vehicle surrounding object is determined as an undetermined control target because recognition accuracy of the vehicle surrounding objects is low, determining the vehicle surrounding object as a control target based on a user command.

According to the present technique, it is possible to increase user satisfaction by effectively notifying a user of a recognition status of an object around a vehicle of an autonomous driving apparatus and improving a recognition function of the object around the vehicle based on user input information.

Furthermore, various effects that can be directly or indirectly identified through this document may be provided.

### BRIEF DESCRIPTION OF THE DRAWINGS

FIG. 1 illustrates a block diagram showing a configuration of a vehicle system comprising an autonomous driving control apparatus according to an exemplary embodiment of the present disclosure.

FIG. 2 illustrates an example of a screen displayed on an interface device according to an exemplary embodiment of the present disclosure.

FIG. 3 illustrates an example of a screen displayed by determining a control target of an autonomous driving control apparatus based on information inputted from a user when recognition of the control target is uncertain according to an exemplary embodiment of the present disclosure.

FIG. 4 illustrates an example of a screen displayed by removing misrecognized obstacle information by a user when an autonomous driving control apparatus misrecognizes vehicle surrounding information according to an exemplary embodiment of the present disclosure.

FIG. 5 illustrates an example of a screen displayed by determining an information usage target of an autonomous driving control apparatus based on information inputted from a user when recognition of the information usage target is uncertain according to an exemplary embodiment of the present disclosure.

FIG. 6 illustrates an example of a screen displayed by determining an obstacle around a vehicle of an autonomous driving control apparatus as a tracking target based on information inputted from a user when recognition of the obstacle is uncertain according to an exemplary embodiment of the present disclosure.

FIG. 7 illustrates a flowchart showing a method of recognizing vehicle surrounding information during autonomous driving control according to an exemplary embodiment of the present disclosure.

FIG. 8 illustrates a computing system according to an exemplary embodiment of the present disclosure.

### DETAILED DESCRIPTION

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

Accordingly, it is possible to enable a user to intuitively recognize a recognition status of an object around an autonomous vehicle by determining uncertainty or misrecognition of the object around the vehicle and displaying it on a display device in the vehicle, and it is possible to increase reliability of an autonomous driving device by performing correction, deletion, change, etc. of recognition information of the object around the vehicle based on information inputted from a user and displaying it.

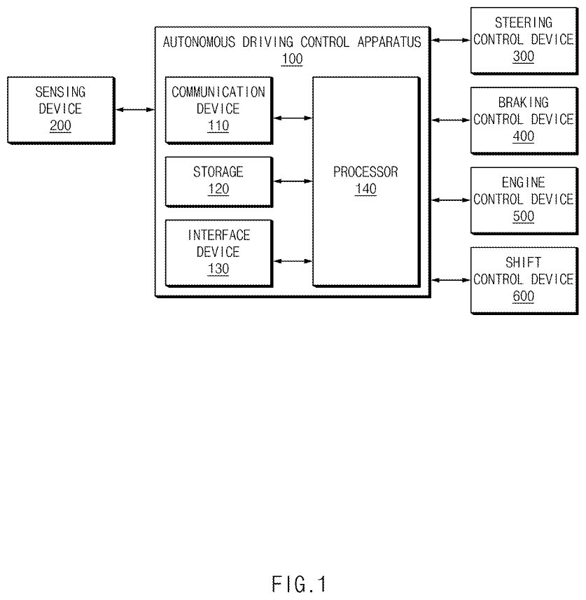

Hereinafter, various exemplary embodiments of the present disclosure will be described in detail with reference to FIG. 1 to FIG. 8.

FIG. 1 illustrates a block diagram showing a configuration of a vehicle system comprising an autonomous driving control apparatus according to an exemplary embodiment of the present disclosure.

The autonomous driving control apparatus 100 according to the exemplary embodiment of the present disclosure may be implemented inside the vehicle. In the instant case, the autonomous driving control apparatus 100 may be integrally formed with internal control units of the vehicle, or may be implemented as a separate device to be connected to control units of the vehicle by a separate connection means.

The autonomous driving control apparatus 100 may be configured to visually classify and display one or more objects around the vehicle (one or more vehicle surrounding objects) based on a recognition status of the objects around the vehicle or a risk degree of the objects around the vehicle based on recognition information of the objects around the vehicle while driving.

In the instant case, the recognition status of the objects surrounding the vehicle may comprise recognition accuracy, and the risk degree of the objects surrounding the vehicle may comprise a possibility of collision with the vehicle. That is, the autonomous driving control apparatus 100 may be configured to differently display recognized objects based on recognition accuracy of the objects surrounding the vehicle or a possibility of collision between the objects and the vehicle.

Furthermore, when the recognition accuracy of the objects around the vehicle is low, the autonomous driving control apparatus 100 may be configured to determine an object surrounding the vehicle as an undetermined control target, and may be configured to determine the object around the vehicle as a control target based on a user command. In the instant case, the control target may comprise a target vehicle for vehicle control. For example, when a vehicle in front is determined as the control target, the vehicle may be controlled to drive while maintaining an inter-vehicle distance from the vehicle in front at a constant distance, and the control target may be controlled to follow it. Furthermore, the undetermined control target refers to an object that has not been determined as the control target because recognition information related to the objects around the vehicle is uncertain.

The autonomous driving control apparatus 100 may comprise a communication device 110, a storage 120, an interface device 130, and a processor 140.

The communication device 110 is a hardware device implemented with various electronic circuits to transmit and receive signals through a wireless or wired connection, and may be configured to transmit and receive information based on in-vehicle devices and in-vehicle network communication techniques. As an example, the in-vehicle network communication techniques may comprise controller area network (CAN) communication, local interconnect network (LIN) communication, flex-ray communication, Ethernet communication, and the like.

Furthermore, the communication device 110 may be configured to perform communication by using a server, infrastructure, or third vehicles outside the vehicle, and the like through a wireless Internet technique or short range communication technique. Herein, the wireless Internet technique may comprise wireless LAN (WLAN), wireless broadband (Wibro), Wi-Fi, world Interoperability for microwave access (Wimax), Ethernet communication, etc. Furthermore, short-range communication technique may comprise bluetooth, ZigBee, ultra wideband (UWB), radio frequency identification (RFID), infrared data association (IrDA), and the like. For example, the communication device 110 may be configured to receive a sensing result from a sensing device 200 to transmit it to the processor 140.

The storage 120 may be configured to store sensing results of the sensing device 200 and data and/or algorithms required for the processor 140 to operate, and the like. As an example, the storage 120 may be configured to store vehicle surrounding information (image data captured through a camera), a vehicle path (driving path from a start point to a destination), and the like. Furthermore, the storage 120 may comprise a database that matches an operation to be performed for each command for recognizing a voice command.

The storage 120 may comprise a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may comprise an input means for receiving a control command from a user and an output means for outputting an operation state of the autonomous driving control apparatus 100 and results thereof. Herein, the input means may comprise a key button, and may further comprise a mouse, a keyboard, a touch screen, a microphone, a joystick, a jog shuttle, a stylus pen, and the like. Furthermore, the input means may further comprise a soft key implemented on the display.

The output means may comprise a display, and may further comprise a voice output means such as a speaker. In the instant case, when a touch sensor formed of a touch film, a touch sheet, or a touch pad is provided on the display, the display may be configured to operate as a touch screen, and may be implemented in a form in which an input device and an output device are integrated. In the instant case, the display may comprise at least one of a liquid crystal display (LCD), a thin film transistor liquid crystal display (TFT LCD), an organic light emitting diode display (OLED display), a flexible display, a field emission display (FED), a 3D display, or any combination thereof. As an example, the interface device 130 may be implemented as a head-up display (HUD), a cluster, an audio video navigation (AVN), a human machine interface (HM), a user setting menu (USM), a monitor, an AR-enabled windshield display, or the like.

For example, the interface device 130 may be configured to mark recognition information of information related to the objects around the vehicle on a path based on the sensing information acquired by the sensing device 200. In addition, the interface device 130 may be configured to display accuracy of the recognition information of the information related to the objects around the vehicle so that a user can intuitively check an accuracy level of the recognition information of the information related to the objects around the vehicle.

Furthermore, the interface device 130 may be configured to mark the information related to the objects around the vehicle that has been modified, changed, or deleted by the processor 140 on the path.

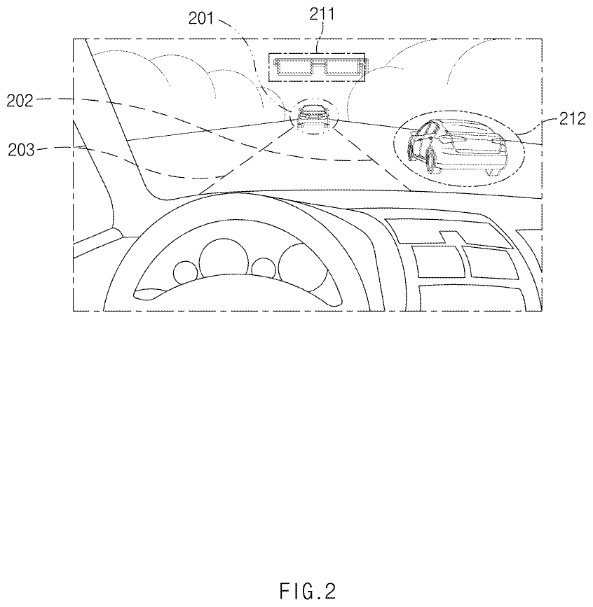

FIG. 2 illustrates an example of a screen displayed on an interface device according to an exemplary embodiment of the present disclosure. Referring to FIG. 2, the interface device 130 may be configured to mark information related to a control target selected by the processor 140 on a driving path. In the instant case, the information related to the control target may comprise control target 201 and lanes 202 and 203 determined as control targets, a control object 211 recognized as an object but undetermined in an uncertain state, a non-control target 212 recognized as an object, etc.

Furthermore, the interface device 130 may be controlled by the processor 140 so that objects may be displayed by applying different colors, thicknesses, and shapes of lines (e.g., circles, squares, underlines, etc.) on which the objects are displayed based on a recognition status (e.g., recognition accuracy, a risk degree of the objects, etc.) of the objects recognized during driving. For example, the determined control target 201, and lanes 202, and 203 may be displayed in red, the object 212 that has been correctly recognized but is not a control target may be displayed in green, and the undetermined control object 211 may be displayed in orange. Furthermore, lines representing objects may be displayed by distinguishing shapes of the lines differently, such as a solid line, a short dotted line, and a long dotted line, based on a recognition status of the objects or a risk degree of the objects. For example, when an object is an obstacle having a risk of collision with the vehicle and when the object is an obstacle having no risk of collision, a color or shape of the object may be displayed differently.

Furthermore, the interface device 130 may be configured to receive a command from a driver, and for this purpose, a mouse, a keyboard, a touch screen, and a microphone may be provided. For example, the interface device 130 may be configured to delete or input confirmation by touching information related to an object around the vehicle marked on the path by a user. Furthermore, the interface device 130 may be configured to receive a voice command. To this end, a voice command inputted through a microphone of the interface device 130 is transferred to the processor 140, and the processor 140 may be configured to recognize the voice command based on a voice recognition algorithm or the like. The voice command may comprise a unique ID and an action to be performed as shown in Table 1 below. For example, when the unique ID is “Vehicle 1” and the action to be performed is “determined”, the voice command may become “vehicle 1 determined”.

TABLE 1

| Commands | Action to be performed |
|---|---|
| Vehicle_1 determined | Confirming vehicle unique ID 1 as control target. |
| Releasing Vehicle_2 | Releasing vehicle unique ID 2 from control target. |
| Deleting Vehicle_3 | Deleting vehicle unique ID 3 from display target. |
| Obstacle_1 tracked | Obstacle unique ID 1 is tracked. |

In addition, the interface device 130 may be configured to simultaneously receive a voice command and a button input from the user. For example, a unique ID may be inputted as a voice command, and an action to be performed may be inputted as a button. In the instant case, the interface device 130 may be configured to receive a button input after a voice input is inputted, or may be configured to simultaneously receive a voice input and a button input.

In addition, the interface device 130 may be configured to provide a user with object recognition information on a driving path as shown in FIG. 2, not only visually, but also through sound, vibration, tactile sense, and the like. For example, the object recognition information on the driving path may be outputted as voice, and may be classified and provided to a user through vibration of a steering wheel or a driver seat.

The processor 140 may be electrically connected to the communication device 110, the storage 120, the interface device 130, and the like, may be configured to electrically control each component, and may be an electrical circuit that executes software commands, thereby performing various data processing and calculations described below.

The processor 140 may be configured to process a signal transferred between components of the autonomous driving control apparatus 100, and may be configured to perform overall control such that each of the components can perform its function normally. The processor 140 may be implemented in the form of hardware, software, or a combination of hardware and software, or may be implemented as microprocessor, and it may be, e.g., an electronic control unit (ECU), a micro controller unit (MCU), or other subcontrollers mounted in the vehicle.

The processor 140 may be configured to enable the user to intuitively recognize recognition information of objects around the vehicle by visually classifying and displaying the objects around the vehicle based on a recognition status of the objects around the vehicle or a risk degree of the objects around the vehicle based on the recognition information of objects around the vehicle recognized through the sensing device 200 while driving.

The processor 140 may be configured to control the objects around the vehicle to be classified and displayed according to at least one of colors of the objects, shapes of lines indicating the objects, colors of the lines indicating the objects, or any combination thereof based on the recognition status of the objects around the vehicle or the risk degree of the objects around the vehicle. For example, the objects around the vehicle may be displayed in the form of a circle, a rectangle, or the like, may be underlined, or may be highlighted and displayed. In the instant case, colors, thicknesses, types, etc. of lines displaying the objects around the vehicle may vary based on the recognition status of the objects around the vehicle or the risk degree of the objects around the vehicle. For example, the objects around the vehicle may be displayed in green when the risk degree of the object around the vehicle is low, and may be displayed in red when the risk degree is high. Furthermore, the objects around the vehicle may be displayed in orange when the recognition accuracy of the objects around the vehicle is low, and may be displayed in light blue when the recognition is high.

Furthermore, the processor 140 may be configured to control the objects around the vehicle to be notified to a user by using at least one of tactile, vibration, auditory, or any combination thereof based on the recognition status of the objects around the vehicle or the risk degree of the objects around the vehicle. That is, when the recognition accuracy of the objects around the vehicle or the risk degree of objects around the vehicle is low, the processor 140 may be configured to weakly output vibration of a driver seat or steering wheel, and may be configured to strongly output the vibration when it is high. To this end, a separate vibration module, a tactile module, and the like may be further included. In addition, for example, the recognition status of the objects around the vehicle or the risk degree of the objects around the vehicle may be outputted by voice to notify a user. For example, when outputting a warning sound, different alarm sound levels may be applied based on the recognition status of the objects around the vehicle or the risk degree of the objects around the vehicle.

The processor 140 may be configured to control the objects around the vehicle to be displayed together with unique IDs by assigning the unique IDs to the objects around the vehicle. For example, the unique IDs may comprise type information and numbers of the objects such as Vehicle 1, Vehicle 2, and Obstacle 1.

When an object surrounding the vehicle is determined as an undetermined control target because the recognition accuracy of the objects around the vehicle is low, the processor 140 may be configured to determine the object around the vehicle as a control target based on a user command.

The processor 140 may be configured to recognize the user command through at least one of voice command recognition, a button operation, a touch input, or any combination thereof, and when the user command is inputted ed as a voice command, the voice command may comprise a unique ID of an object around the vehicle and an action to be performed. For example, when the voice command is “Vehicle 1, determined”, it is a command to determine an object corresponding to Vehicle 1 as a control target.

In the instant case, the unique IDs may be given based on type information of objects around the vehicle, and the action to be performed may comprise at least one of actions of determining an object around the vehicle as a control target, releasing a control target of an object determined as the control target, deleting misrecognized objects around the vehicle or any combination thereof.

When the recognition accuracy of the objects around the vehicle is lower than a predetermined reference value, the processor 140 may be configured to control the objects around the vehicle to be displayed in a first color or a first shape, and when an object around the vehicle is determined as a control target based on a user command, may be configured to control the object around the vehicle to be marked in a second color or in a second shape on a driving path.

When it is necessary to track an object around the vehicle based on a user command, the processor 140 may be configured to control the object around the vehicle to be displayed in a third color or a third shape. When the object around the vehicle is determined as a tracking target, the processor 140 may be configured to control the vehicle to maintain a safe distance with the tracking target, and may be configured to continue to track the object around the vehicle.

When the recognition accuracy of the object around the vehicle is lower than a predetermined reference value and the object around the vehicle is determined as a target for providing information rather than a control target, the processor 140 may be configured to control the objects around the vehicle to be marked in the first color or the first shape on the driving path, may be configured to control an unique ID of the object for providing information to be displayed together, and when an object around the vehicle is determined as an information usage target according to a user command, may be configured to control the object around the vehicle to be displayed in a fourth color or a fourth shape. The processor 140 may be configured to control an object around the vehicle to be displayed in a fifth color or fifth shape on the driving path when the object around the vehicle is not the control target. When the recognition accuracy of the objects around the vehicle is smaller than a predetermined reference value, the processor 140 may be configured to control the objects around the vehicle to be marked in the first color or in the first shape on the driving path, and may be configured to delete the marking of the objects around the vehicle on the driving path based on the user command.

The sensing device 200 may be configured to detect an environment around the vehicle (lane information, etc.), an object around the vehicle, and the like, and the objects around the vehicle may comprise a vehicle, a pedestrian, a bicycle or a motorcycle, a puddle of water on a road surface, a building, a sign, and the like. The sensing device 200 may comprise a plurality of sensors for detecting objects around the vehicle, and may be configured to acquire positions of the objects around the vehicle, speeds of the objects around the vehicle, acceleration of the objects around the vehicle, travel directions of the objects around the vehicle, sizes of the objects around the vehicle, and/or information related to types of the objects around the vehicle (e.g., vehicles, pedestrians, bicycles or motorcycles, etc.), lane information, etc. To this end, the sensing device 200 may comprise an ultrasonic sensor, a radar, a camera, a laser scanner, and/or a corner radar, a lidar, an acceleration sensor, a yaw rate sensor, a torque measurement sensor and/or a wheel speed sensor, a steering angle sensor, etc.

A steering control device 300 may be configured to control a steering angle of a vehicle, and may comprise a steering wheel, an actuator interlocked with the steering wheel, and a controller controlling the actuator. The steering control device 300 may be implemented as motor driven power steering).

A braking control device 400 may be configured to control braking of the vehicle, and may comprise a controller that controls a brake thereof. The braking control device may be implemented as an electronic stability control (ESC).

An engine control device 500 may be configured to control engine driving of a vehicle, and may comprise a controller that controls a speed of the vehicle. The engine control device 500 may be implemented as an engine management system (EMS).

A shift control device 600 may be configured to control shift of the vehicle, may be implemented as a shift by wire control unit (SCU), or the like, and may be configured to control target shift stages (P/R/N/D).

As such, according to the present disclosure, reliability of an autonomous vehicle may be increased by increasing accuracy of recognition of vehicle surrounding information of the autonomous vehicle by effectively notifying a user of a recognition status of obstacles on a driving path during autonomous driving, and modifying, changing, or deleting them based on the recognition status of the obstacles, etc.

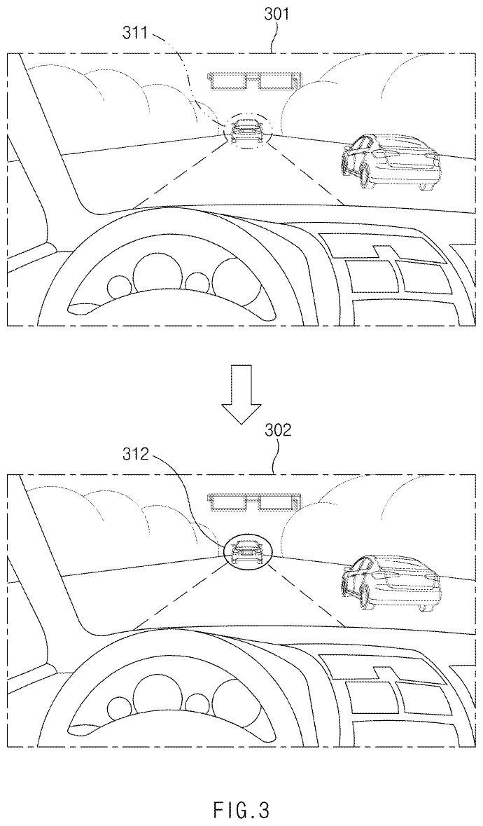

FIG. 3 illustrates an example of a screen displayed by determining a control target of an autonomous driving control apparatus based on information inputted from a user when recognition of the control target is uncertain according to an exemplary embodiment of the present disclosure.

Referring to a screen 301 of FIG. 3, when the autonomous driving control apparatus 100 recognizes an object in front on a driving path but the recognition is uncertain, the corresponding object may be displayed as an undetermined control target 311 with a predetermined color, a thickness of a dotted line, hatching, and the like. In the instant case, as shown in the screen 301, although the object is recognized as a vehicle, the accuracy is low, so the undetermined control target 311 may be determined, and a unique ID may be assigned to each unconfirmed control target 311 to be displayed. For example, the undetermined control target 311 may have a unique ID displayed as Vehicle 1, Vehicle 2, or the like.

Accordingly, a user may check that the undetermined control target 311 exists on the driving path, and the autonomous driving control apparatus 100 may be configured to receive a command for changing the undetermined control target 311 into a determined control target or a tracking target or deleting it from the user. To this end, the autonomous driving control apparatus 100 may be configured to enable the undetermined control target 311 to be touched on a screen by the user, or may be configured to receive a voice command from the user.

Referring to a screen 302, an example in which the autonomous driving control apparatus 100 changes the undetermined control target 311 to a determined control target 312 on the screen 301 and displays it based on a user command is disclosed. For example, the undetermined control target 311 may be displayed in orange and the determined control target 312 may be displayed in red. As such, the autonomous driving control apparatus 100 may be configured to display the object by applying different colors based on recognition status of the object recognized during driving (e.g., recognition accuracy, a risk degree of the object, etc.).

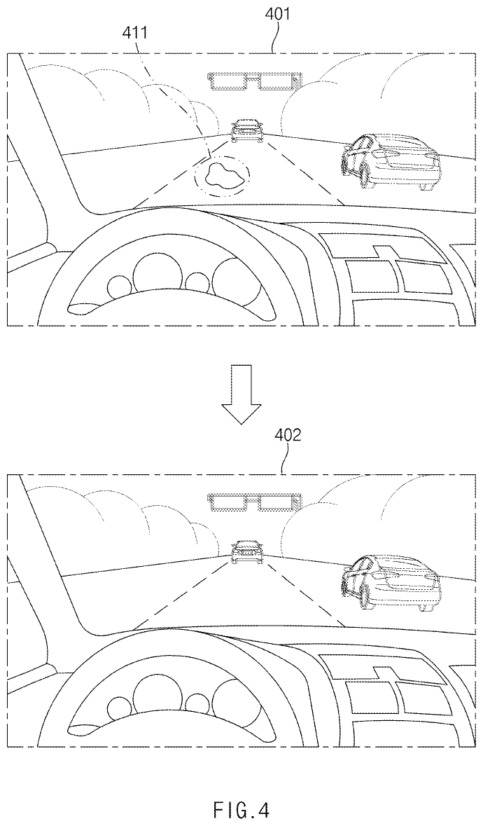

FIG. 4 illustrates an example of a screen displayed by removing misrecognized obstacle information by a user when an autonomous driving control apparatus misrecognizes vehicle surrounding information according to an exemplary embodiment of the present disclosure.

Referring to a screen 401 of FIG. 4, the autonomous driving control apparatus 100 may misrecognize a shallow water puddle on the driving path as an obstacle and display an undetermined control target 411. In the instant case, the undetermined control target 411, which is a general obstacle other than a vehicle or a pedestrian, may be displayed as Obstacle_1 or the like.

Accordingly, a user may check that the undetermined control target 411 exists on the driving path, and the autonomous driving control apparatus 100 may be configured to receive a command for changing the undetermined control target 411 into a determined control target or a tracking target or deleting it from the user.

Referring to a screen 402, an example in which the autonomous driving control apparatus 100 deletes the undetermined control target 311 on the screen 302 and displays it based on a user command is disclosed.

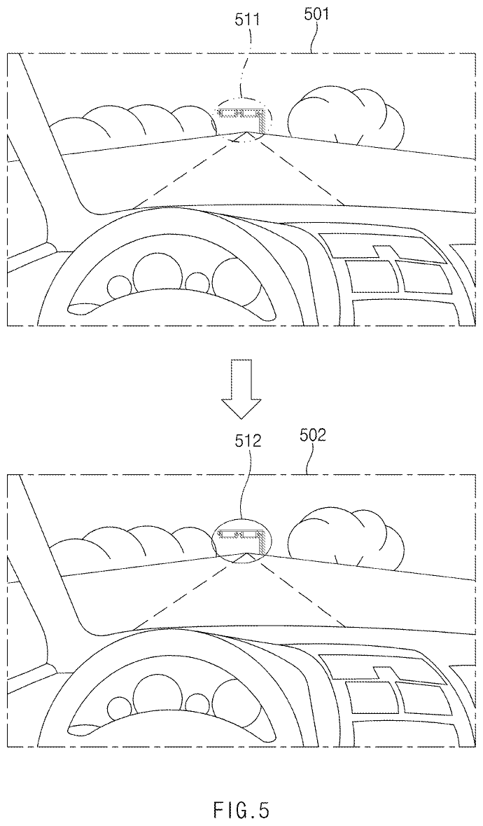

FIG. 5 illustrates an example of a screen displayed by determining an information usage target of an autonomous driving control apparatus based on information inputted from a user when recognition of the information usage target is uncertain according to an exemplary embodiment of the present disclosure.

Referring to a screen 501 of FIG. 5, when the autonomous driving control apparatus 100 recognizes an object in front on a driving path but the recognition is uncertain, the corresponding object may be displayed as an undetermined control target 511 with a predetermined color, a thickness of a dotted line, hatching, and the like. In the instant case, the autonomous driving control apparatus 100 may be configured to display that the undetermined control target 511 is an object for information usage, such as a sign. For example, the undetermined control target 511 may be displayed as Sign_1.

Accordingly, a user may check that the undetermined control target 511 exists on the driving path, and the autonomous driving control apparatus 100 may be configured to receive a command for changing the undetermined control target 511 into an information usage target or a tracking target or deleting it from the user.

Referring to a screen 502, an example in which the autonomous driving control apparatus 100 determines the undetermined control target 511 as the information usage target 512 other than a collision control target on the screen 501 and displays it based on a user command is disclosed. For example, the undetermined control target 511 may be displayed in orange and the information usage target 512 may be displayed in blue.

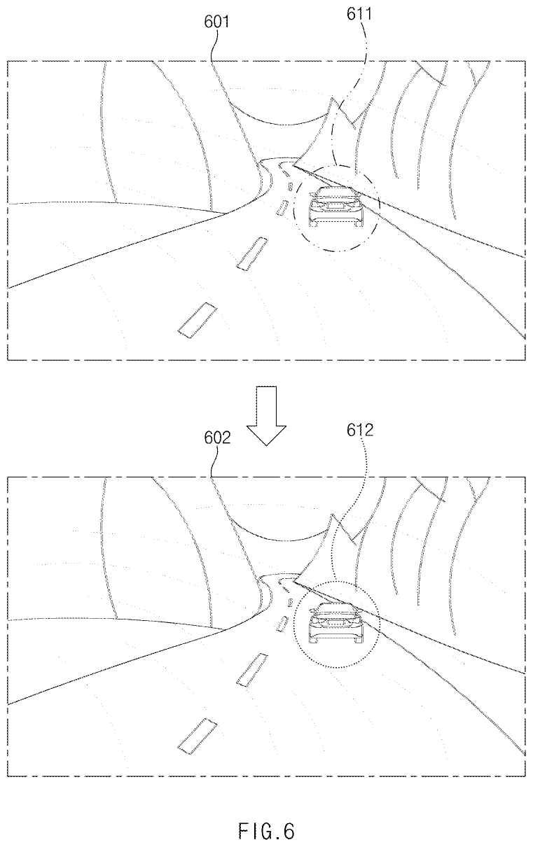

FIG. 6 illustrates an example of a screen displayed by determining an obstacle around a vehicle of an autonomous driving control apparatus as a tracking target based on information inputted from a user when recognition of the obstacle is uncertain according to an exemplary embodiment of the present disclosure.

Referring to a screen 601 of FIG. 6, when the autonomous driving control apparatus 100 recognizes an object in front on a driving path but the recognition is uncertain, the corresponding object may be displayed as an undetermined control target 611 with a predetermined color, a thickness of a dotted line, hatching, and the like. In the instant case, in a screen 601, an undetermined control target 611 may be recognized as an uncertain obstacle, and for example, the undetermined control target 611 may be displayed as Obstacle_1.

Accordingly, a user may check that the undetermined control target 611 exists on the driving path, and the autonomous driving control apparatus 100 may be configured to receive a command for changing the undetermined control target 611 into a determined control target or a tracking target or deleting it from the user.

Referring to a screen 602, an example in which the autonomous driving control apparatus 100 changes undetermined control target 611 to a tracking target 612 on the screen 601 and displays it based on a user command is disclosed. That is, when it is difficult for a user to accurately recognize the undetermined control target 611, the autonomous driving control apparatus 100 may be configured to receive a command for continuous tracking from the user, and when a command for continuous tracking is inputted, the undetermined control target 611 may be determined as the tracking target 612. For example, the undetermined control target 611 may be displayed in orange and the tracking target 612 may be displayed in purple

Furthermore, when the tracking target 612 exists on the driving path, the autonomous driving control apparatus 100 may not perform emergency braking, but may be configured to perform safety distance control, etc. to prevent a collision with the tracking target 612.

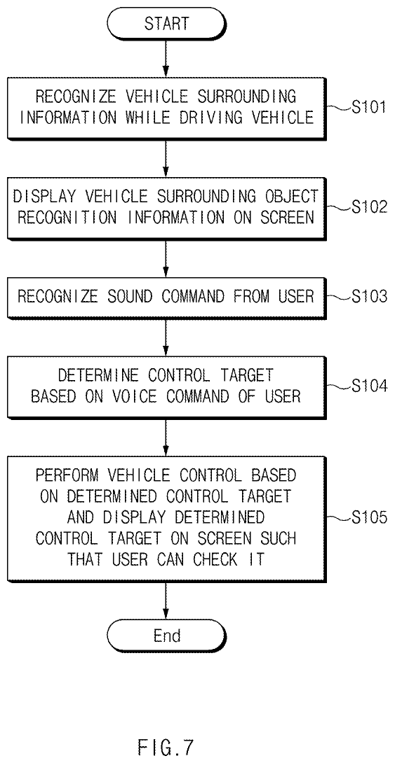

Hereinafter, an autonomous driving control method according to an exemplary embodiment of the present disclosure will be described in detail with reference to FIG. 7. FIG. 7 illustrates a flowchart showing a method of recognizing vehicle surrounding information during autonomous driving control according to an exemplary embodiment of the present disclosure.

Hereinafter, it is assumed that the autonomous driving control apparatus 100 of the of FIG. 7 performs processes of FIG. 7. In addition, in the description of FIG. 7, operations described as being performed by a device may be understood as being controlled by the processor 140 of the autonomous driving control apparatus 100.

Referring to FIG. 7, the autonomous driving control apparatus 100 may be configured to use the sensing device 200 to recognize vehicle surrounding information while driving the vehicle (S101).

The autonomous driving control apparatus 100 may be configured to mark recognized vehicle surrounding object recognition information on a driving path to output it to a display device of the vehicle (S102). In the instant case, the vehicle surrounding object recognition information may be displayed in different colors, shapes, etc. based on a recognition status (uncertainty, certainty, misrecognition, etc.), a risk degree (or reliability) of an object, and the like. As illustrated in FIG. 2 described above, the autonomous driving control apparatus 100 may be configured to display the object as a determined control target when the recognition of the object around the vehicle is uncertain or misrecognized, and among reliably recognized objects, colors and shapes of a controlled object and an uncontrolled object may be displayed differently to distinguish them. Accordingly, a user may intuitively check the vehicle surrounding object recognition information while driving. Furthermore, a recognized vehicle surrounding object is given a unique ID to enable the unique ID to be displayed together, so that a user can identify a type of the object through the unique ID. In the instant case, the unique ID may be predetermined and stored.

Then, the autonomous driving control apparatus 100 may be configured to receive a command inputted from the user to determine the undetermined control target, and in particular, may be configured to recognize a voice command that is inputted from the user (S103). In the instant case, the autonomous driving control apparatus 100 may be configured to recognize the voice command based on a previously stored voice command recognition database. Furthermore, the voice command may comprise a unique ID and an action to be performed. In the instant case, information related to the action to be performed may be predefined and stored, and may comprise, e.g., actions to be performed, such as determination, release, deletion, and tracking.

The autonomous driving control apparatus 100 may be configured to determine an undetermined control target as a control target based on a voice command recognition result of the user (S104).

Furthermore, when the undetermined control object is a vehicle, the autonomous driving control apparatus 100 may be configured to determine it as a control target or a non-control target, and when the undetermined control target is an obstacle, may be configured to delete an undetermined control target or select it as a tracking target based on whether misrecognition is performed.

The autonomous driving control apparatus 100 may be configured to perform vehicle control based on the determined control target and display the determined control target on the screen such that the user can check it (S105). That is, the autonomous driving control apparatus 100 may be configured to control a speed and steering of the vehicle to avoid a collision with the object determined as the control target.

As such, according to the present disclosure, anxiety and fatigue of the user caused by not providing information may be minimized by enabling the user to intuitively check the vehicle surrounding object recognition information on the path while driving. Furthermore, according to the present disclosure, it is possible to improve a vehicle surrounding object recognition performance by making it possible to correct misrecognition information of surrounding object information based on the user command when vehicle surrounding object information is misrecognized.

Furthermore, according to the present disclosure, objects may be displayed in different colors, shapes, etc. based on a recognition status of the vehicle surrounding object recognition information, a risk degree or reliability of the objects, etc., thereby enabling the user to intuitively check them while driving.

Furthermore, according to the present disclosure, when a user recognizes a voice command for correcting, deleting, etc., of the vehicle surrounding object recognition information, it is possible to improve recognition accuracy of the voice command by configuring a unique ID and an action to be performed as the voice command,

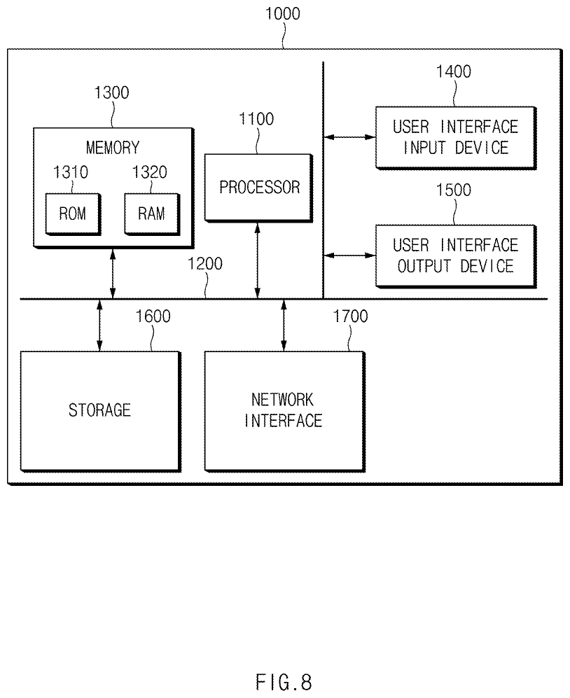

FIG. 8 illustrates a computing system according to an exemplary embodiment of the present disclosure.

Referring to FIG. 8, the computing system 1000 may comprise at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may comprise various types of volatile or nonvolatile storage media. For example, the memory 1300 may comprise a read only memory (ROM) and a random access memory (RAM).

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. An autonomous driving control apparatus, comprising:
an interface device configured to display a driving path of a vehicle and one or more vehicle surrounding objects; and
a processor configured to visually classify and display the one or more vehicle surrounding objects on the interface device based on a recognition status of the one or more vehicle surrounding objects or a risk degree of the vehicle surrounding objects, based on recognition information of the one or more vehicle surrounding objects while driving.

2. The autonomous driving control apparatus of claim 1, wherein the processor, based on the recognition status of the one or more vehicle surrounding objects or the risk degree of the vehicle surrounding objects, is configured to:
control the one or more vehicle surrounding objects to be classified and displayed according to one or more of the following: colors of the one or more vehicle surrounding objects;
and shapes of the one or more vehicle surrounding objects.

3. The autonomous driving control apparatus of claim 1, wherein the processor is configured to:
control the one or more vehicle surrounding objects to be notified to a user by using one or more of tactile, vibration, and auditory, based on the recognition status of the one or more vehicle surrounding objects or the risk degree of the one or more vehicle surrounding objects.

4. The autonomous driving control apparatus of claim 1, wherein the risk degree of the one or more vehicle surrounding objects comprises a possibility of collision with a vehicle.

5. The autonomous driving control apparatus of claim 1, wherein the processor is configured to:
control the one or more vehicle surrounding objects to be displayed together with unique IDs by assigning the unique IDs to the one or more vehicle surrounding objects.

6. The autonomous driving control apparatus of claim 1, wherein the processor, when a vehicle surrounding object, of the one or more vehicle surrounding objects, is determined as an undetermined control target because recognition accuracy of the one or more vehicle surrounding objects is low, is configured to:
determine the vehicle surrounding object as a control target, based on a user command.

7. The autonomous driving control apparatus of claim 6, wherein the processor is configured to:
recognize the user command through one or more of the following: voice command recognition; a button operation; and a touch input.

8. The autonomous driving control apparatus of claim 6, wherein, when the user command is inputted as a voice command, the voice command comprises:
a unique ID of the vehicle surrounding object; and
an action to be performed.

9. The autonomous driving control apparatus of claim 8, wherein:
the unique ID is given based on type information of the vehicle surrounding object, and
the action to be performed comprises one or more of:
determining the vehicle surrounding object as a control target;
releasing a control target of an object determined as the control target; and
deleting a misrecognized vehicle surrounding object.

10. The autonomous driving control apparatus of claim 1, wherein the processor is configured to:
control the one or more vehicle surrounding objects to be displayed in a first color or a first shape when recognition accuracy of the one or more vehicle surrounding objects is lower than a predetermined reference value; and
control a vehicle surrounding object to be marked in a second color or in a second shape on a driving path when the vehicle surrounding object is determined as a control target based on a user command.

11. The autonomous driving control apparatus of claim 10, wherein the processor is configured to:
control the vehicle surrounding object to be displayed in a third color or in a third shape when it is necessary to track the vehicle surrounding object, based on the user command.

12. The autonomous driving control apparatus of claim 11, wherein the processor is configured to:
control the vehicle to maintain a safe distance with a tracking target; and
continue to track the vehicle surrounding object when the vehicle surrounding object is determined as the tracking target.

13. The autonomous driving control apparatus of claim 11, wherein the processor is configured to:
control the vehicle surrounding object to be marked in the first color or the first shape on the driving path;
control a unique ID of an object for providing information to be displayed together when:
recognition accuracy of the vehicle surrounding object is lower than a predetermined reference value; and
the vehicle surrounding object is determined as a target for providing information rather than a control target; and
control the vehicle surrounding object to be displayed in a fourth color or a fourth shape when the vehicle surrounding object is determined as an information usage target, based on the user command.

14. The autonomous driving control apparatus of claim 13, wherein the processor is configured to:
control an object around the vehicle to be marked in a fifth color or fifth shape on the driving path when the vehicle surrounding object is not the control target.

15. The autonomous driving control apparatus of claim 1, wherein the processor is configured to:
control a vehicle surrounding object to be marked in a first color or a first shape on a driving path when recognition accuracy of the vehicle surrounding object is lower than a predetermined reference value; and
delete the marking of the vehicle surrounding object on the driving path, based on a user command.

16. The autonomous driving control apparatus of claim 1, wherein the interface device comprises one or more of the following:
a head-up display (HUD);
a cluster;
an audio video navigation (AVN);
a human machine interface (HM);
a user setting menu (USM);
a monitor; and
an AR-enabled windshield display.

17. A vehicle system comprising:
a sensing device configured to acquire:
vehicle surrounding object information; and
vehicle surrounding environment information; and
an autonomous driving control apparatus configured to visually classify and display one or more vehicle surrounding objects based on a recognition status of the one or more vehicle surrounding objects or a risk degree of the one or more vehicle surrounding objects based on recognition information of the vehicle surrounding objects while driving.

18. An autonomous driving control method comprising:
acquiring, by a processor, recognition information of one or more vehicle surrounding objects while driving; and
visually classifying, by the processor, and displaying the one or more vehicle surrounding objects, based on a recognition status of the one or more vehicle surrounding objects or a risk degree of the one or more vehicle surrounding objects based on recognition information of the one or more vehicle surrounding objects.

19. The autonomous driving control method of claim 18, wherein the visually classifying and displaying of the one or more vehicle surrounding objects comprises, by a processor, based on the recognition status of the one or more vehicle surrounding objects or the risk degree of the one or more vehicle surrounding objects:
controlling one or more vehicle surrounding objects to be classified and displayed according to at least one of colors of the one or more vehicle surrounding objects or shapes of the one or more vehicle surrounding objects.

20. The autonomous driving control method of claim 19, wherein the visually classifying and displaying of the one or more vehicle surrounding objects further comprises:
when a vehicle surrounding object is determined as an undetermined control target because recognition accuracy of the vehicle surrounding objects is low, determining, by a processor, the vehicle surrounding object as a control target based on a user command.
